(19) United States
(12) Patent Application Publication
(10) Pub. No.: US 2006/0185273 A1
(43) Pub. Date: Aug. 24, 2006

(54) Glazing system

(76) Inventor: Arakkal Abdul Khader Lathief, Dubai (AE)

Correspondence Address: GARVEY SMITH NEHRBASS & NORTH, LLC, LAKEWAY 3, SUITE 3290, 3838 NORTH CAUSEWAY BLVD., METAIRIE, LA, 70002, US

(21) Appl. No.: 10/566,536

(22) PCT Filed: Jul. 15, 2004
(86) PCT No.: PCT/IB04/02298

§ 371 Date: Jan. 30, 2006

(30) Foreign Application Priority Data
Jul. 30, 2003 (AE) 242/2003

(51) Int. Cl. E06B 3/988

(52) U.S. Cl. 52/204.71

(57) ABSTRACT

The current invention relates to a unique and compact self locking mechanism, composed of two aluminum profiles designed in such a way to self lock when Glass is placed on the female profile and the male profile is inserted and the mechanism further tightens grip on the glass edges when pushed in a grooved rubber.

### DETAILED DESCRIPTION

1. Technical Field

The current invention relates to a unique and compact self locking mechanism, composed of two aluminum profiles designed in such a way to self lock when Glass is placed on the female profile and the male profile is inserted and the mechanism further tightens grip on the glass edges when pushed in a grooved rubber (which is mandatory for glazing to avoid touching metal, to allow expansion and to absorb impacts).

2. Technical Background

U.S. Pat. No. 5,007,221 entitled “A SNAP-IN GLAZING POCKET FILLER” is disclosed a snap-in pocket filler for use with a structural frame member having an unused Glazing Pocket” or to be used as a Gap Filler on Aluminum Profiles to cover the unused area for aesthetic reason.

It was noticed that a proper glazing system was lacking in the market to meet the increasing demand for thicker Glazing (e.g.: shop fronts & partitions) and it has become a necessity for those skilled in the art to develop a system which must be simple, technically safe and aesthetically impressive.

### DISCLOSURE OF THE INVENTION

Aluminum profiles generally available now are intended for standard window glazing and used by many for thicker glazing by compromising safety; quality and aesthetic appeal as no other are options available. For maximum visibility of the showrooms, designers insist frameless glazing with lighter frames around. Technicians use “U” channels, in which glass panels allowed to stand free and thus tend to move horizontally due to loose fixing at ends with silicone.

Some professional pioneers like Dorma (Germany) developed heavy profiles for thicker glass application which requires fastening by screws which further should be covered for aesthetic reasons and consequently the work becomes complicated, laborious and eventually expensive.

In view of the above factors and considering the demand for faster glazing, the current invention emphasizes the issue of safety and at the same time addresses the importance for aesthetic appeal, allowing enough clearance for glazing (one could decide glass size before installing frames at site) and making site installation easy.

### BRIEF DESCRIPTION OF THE DRAWINGS

FIG. 1 & FIG. 2: Female and Male profiles.

FIG. 3: Fixing of profile using a screw.

FIG. 4: Glass Packing on the part 2 Profile (minimum 2 per Glass panel).

FIG. 5: 10 mm thick Glass (suitable to the frame size) placed over the Part 2 profile in FIG. 5.

FIG. 6: Profile Part 1 through the gap on Profile Part 2.

FIG. 7: Insertion of grooved rubber beading between the gap of profiles from both sides of the glass panel using force.

FIG. 8: Scientific principle of the mechanism of the glazing system explained.

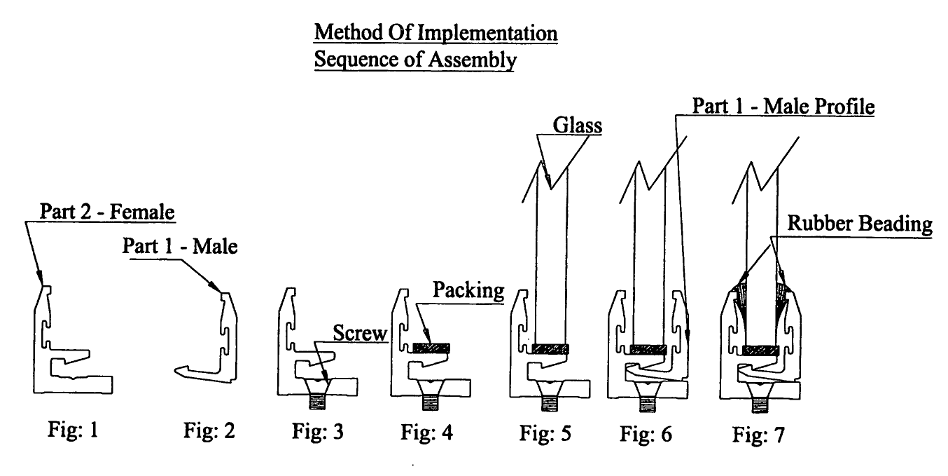

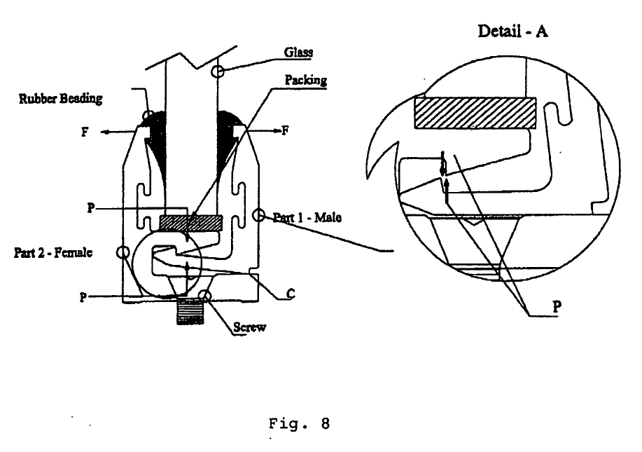

### PREFERRED EMBODIMENTS OF THE INVENTION

The Glazing System consists of two extruded Aluminum profiles (Male & Female) designed in such a way to create a secure space for keeping Glass Panels safely & tightly in position. The important aspect of the invention is that when the Glass panels placed on the Female profile and the Male profile is inserted and the Rubber beading is forced in (by hand) between the Glass & Profiles (both sides) creates outward forces on the upper legs of the profiles (forcing them apart). The turning movements at the pivotal fulcrum forces the locking system together which is due to the curved hooking parts on the profiles (at bottom) engage each other to self lock and thus arrest the profiles in position.

### METHOD OF INDUSTRIAL APPLICATION OF THE INVENTION

The scientific principles used are the NEWTON'S LAW OF FORCE and the property of Elasticity of the rubber beading and the transmission of the rotational moments of the moving parts around the Fulerum. The following explanation is read in relation to FIG. 8:
F—Outward Force (Due to Rubber Beading)
P—Inward Force (Creating the Locking)
C—Fulcrum Point

Insertion of the rubber beading between the glass and the profile sections (Part 1 & 2) creates outward forces (F) to the legs of both sections forcing them apart “F”. A turning moment at the pivotal fulcrum (C) forces the locking system together (P). The locking system is due t the curved hooking profile of the lock built into the legs of the sections (Male & Female) creating mating edges, hence arresting the profile section in position.

The pre-determined variables are the sizing of the glass and that of the rubber beading. In this arrangement any external forces applied due to conditions like wind or vibrations caused by physical movements whose action may act to dislodge the Glass from its set position only acts to further tighten the fastening mechanism of this system to arrest the Glass panel in position.

1. A self locking mechanism, composed of two aluminum profiles designed in such as way to self lock when Glass is placed on the female profile and the male profile is inserted and the mechanism further tightens grip on the glass edges when pushed in a grooved rubber.

2. A self locking glazing system comprising:
(a) a female profile, the female profile having an upper tip, a base, and a gap, the gap being located at the base, and the gap including upper and lower portions;
(b) a male profile, the male profile having an upper tip, a leg, and a fulcrum;
(c) the leg interlocking with the gap; and
(d) the upper portion of the gap providing a support area for a glass which can be locked by the glazing system; and
(e) wherein the opposite forces in opposite directions are placed on the respective tips of the male and female profiles.

3. The self locking glazing system of claim 2, wherein the base of the female profile has a center, and the leg of the male profile passes the center when inserted into the gap.

4. The self locking glazing system of claim 2, wherein the upper portion of the gap has a downwardly sloped portion which ends in a cavity, and the leg of the male profile interlocks with the cavity.

5. The self locking glazing system of claim 4, wherein the leg of the male profile has an enlarged tip which interlocks with the cavity.

6. The self locking glazing system of claim 2, wherein the forces in opposite direction tend to cause the male profile to attempt to rotate in a direction opposite that of the female profile.

7. The self locking glazing system of claim 6, wherein the male profile attempts to rotate around the fulcrum.

8. The self locking glazing system of claim 7, wherein the fulcrum rests on the base of the female profile.

9. The self locking glazing system of claim 2, wherein a vertical plane passing through the center of the glass will intersect both the male and female profiles, and also intersect the gap of the female profile and the leg of the male profile.

10. The self locking glazing system of claim 9, wherein the vertical plane will intersect both the upper and lower portions of the gap.

11. The self locking glazing system of claim 2, wherein the upper portion of the gap for supporting the glass is flat.

12. The self locking glazing system of claim 2, wherein the lower portion of the base of the female profile is flat.

13. The self locking glazing system of claim 2, wherein the tip of the female portion and the tip of the male portion are located at the same height when connected.
